(19) United States
(12) Patent Application Publication
(10) Pub. No.: US 2018/0288799 A1
(43) Pub. Date: Oct. 4, 2018

(54) ENHANCED CHANNEL ACCESS MECHANISM TO IMPROVE WIRELESS UPLINK THROUGHPUT PERFORMANCE

(71) Applicant: Intel Corporation, Santa Clara, CA (US)

(72) Inventors: Alexander W. Min, Portland, OR (US); Juan Fang, Portland, OR (US); Minyoung Park, Portland, OR (US)

(73) Assignee: Intel Corporation, Santa Clara, CA (US)

(21) Appl. No.: 15/475,403

(22) Filed: Mar. 31, 2017

(51) Int. Cl. H04W 74/08; H04W 74/00

(52) U.S. Cl. CPC H04W 74/0808; H04W 74/004

(57) ABSTRACT

A wireless device, system and method. The device includes a memory and processing circuitry. The processing circuitry includes logic and is configured to cause transmission of a first uplink frame on a first channel, and while causing transmission of the first uplink frame: to perform channel sensing on a second channel to determine a busy or an idle status of the second channel; and, in response to a determination of an idle status for the second channel, to perform a backoff procedure to gain access to the second channel In response to a determination that the second channel still has an idle status after completion of the backoff procedure and after completion of the transmission of the first uplink frame, the processing circuitry is further configured to cause a switch to the second channel and to cause transmission of a second uplink frame on the second channel.

### TECHNICAL FIELD

An exemplary aspect is directed toward communications systems. More specifically an exemplary aspect is directed toward wireless communications systems and even more specifically to IEEE (Institute of Electrical and Electronics Engineers) 802.11 wireless communications systems. Even more specifically, exemplary aspects are at least directed toward one or more of IEEE (Institute of Electrical and Electronics Engineers) 802.11n/ac/ax/ . . . communications systems and in general any wireless communications system or protocol, such as 4G, 4G LTE, 5G and later, and the like.

### BACKGROUND

Wireless networks transmit and receive information utilizing varying techniques and protocols. For example, but not by way of limitation, two common and widely adopted techniques used for communication are those that adhere to the Institute for Electronic and Electrical Engineers (IEEE) 802.11 standards such as the IEEE 802.11n standard, the IEEE 802.11ac standard and/or the IEEE 802.11ax standard.

The IEEE 802.11 standards specify a common Medium Access Control (MAC) Layer which provides a variety of functions that support the operation of IEEE 802.11-based Wireless LANs (WLANs) and devices. The MAC Layer manages and maintains communications between IEEE 802.11 stations (STAs) by coordinating access to a shared radio channel and utilizing protocols that enhance communications over a wireless medium.

IEEE 802.11ax is the successor to IEEE 802.11ac and is proposed to increase the efficiency of WLAN networks, especially in high density areas like public hotspots and other dense traffic areas. IEEE 802.11ax also uses orthogonal frequency-division multiple access (OFDMA), and related to IEEE 802.11ax, the High Efficiency WLAN Study Group (HEW SG) within the IEEE 802.11 working group is considering improvements to spectrum efficiency to enhance system throughput/area in high density scenarios of APs (Access Points) and/or STAs (Stations).

Due to the propagation loss, a STA at the edge of the coverage area of a basic service set (BSS) (a “cell edge” STA or CE STA), the physical data rate to the CE STA tends to be much lower than that to a non-cell-edge STA (non-CE STA). For example, in an environment with three access points (APs) located at the three corners of a large 40 m×40 m room, a STA will follow the rules defined in IEEE 802.11 specification to connect with the nearest AP. The physical data rate to the STA in the middle of the room is much lower than that for a second STA near one of the three corners, where the STA is closer to the AP. Thus, CE STAs continue to underperform in many networks, and there exists a need to improve throughput and performance at CE STAs.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a coordinated multi-access point network including one station (STA) and three access points (APs), in accordance with some demonstrative embodiments;

FIG. 2 is a graph plotting physical data rate from an AP to a STA versus distance of the AP from the STA for various channel bandwidths in conformance with the Institute of Electrical and Electronics Engineers (IEEE) 802.11ac standard amendment or protocol;

FIG. 3 is a radio architecture for a STA or an AP from the BSS of FIG. 1 in accordance with some demonstrative embodiments;

FIG. 4 shows a signal exchange between a STA, such as a CE STA, and three APs according to some demonstrative embodiments;

FIG. 5 illustrates a product of manufacture in accordance with some demonstrative embodiments; and

FIG. 6 illustrates a flow-chart of a method according to some demonstrative embodiments.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

References to “one embodiment”, “an embodiment”, “demonstrative embodiment”, “various embodiments” etc., indicate that the embodiment(s) so described may include a particular feature, structure, or characteristic, but not every embodiment necessarily includes the particular feature, structure, or characteristic. Further, repeated use of the phrase “in one embodiment” does not necessarily refer to the same embodiment, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

Some embodiments may be used in conjunction with various devices and systems, for example, a User Equipment (UE), a Mobile Device (MD), a wireless station (STA), a Personal Computer (PC), a desktop computer, a mobile computer, a laptop computer, a notebook computer, a tablet computer, a server computer, a handheld computer, a handheld device, a wearable device, a sensor device, an Internet of Things (IoT) device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some embodiments may be used in conjunction with devices and/or networks operating in accordance with existing and/or published IEEE 802.11 standards or amendments (including IEEE 802.11ax, IEEE 802.11-2012 (IEEE 802.11-2012, IEEE Standard for Information technology—Telecommunications and information exchange between systems Local and metropolitan area networks—Specific requirements Part 11: Wireless LAN Medium Access Control (MAC) and Physical Layer (PHY) Specifications, Mar. 29, 2012); IEEE802.11ac-2013 (“IEEE P802.11ac-2013, IEEE Standard for Information Technology—Telecommunications and Information Exchange Between Systems—Local and Metropolitan Area Networks—Specific Requirements—Part 11: Wireless LAN Medium Access Control (MAC) and Physical Layer (PHY) Specifications—Amendment 4: Enhancements for Very High Throughput for Operation in Bands below 6 GHz”, December, 2013); IEEE 802.11ad (“IEEE P802.11ad-2012, IEEE Standard for Information Technology—Telecommunications and Information Exchange Between Systems—Local and Metropolitan Area Networks—Specific Requirements—Part 11: Wireless LAN Medium Access Control (MAC) and Physical Layer (PHY) Specifications—Amendment 3: Enhancements for Very High Throughput in the 60 GHz Band”, 28 Dec. 2012); IEEE-802.11REVmc (“IEEE 802.11-REVmcTM/D3.0, June 2014 draft standard for Information technology—Telecommunications and information exchange between systems Local and metropolitan area networks Specific requirements; Part 11: Wireless LAN Medium Access Control (MAC) and Physical Layer (PHY) Specification”); IEEE 802.11ax (IEEE 802.11ax, High Efficiency WLAN (HEW)); IEEE802.11-ay (P802.11ay Standard for Information Technology—Telecommunications and Information Exchange Between Systems Local and Metropolitan Area Networks—Specific Requirements Part 11: Wireless LAN Medium Access Control (MAC) and Physical Layer (PHY) Specifications—Amendment: Enhanced Throughput for Operation in License-Exempt Bands Above 45 GHz)) and/or future versions and/or derivatives thereof) and/or future versions and/or derivatives thereof, devices and/or networks operating in accordance with existing Wireless-Gigabit-Alliance (WGA) specifications (Wireless Gigabit Alliance, Inc WiGig MAC and PHY Specification Version 1.1, April 2011, Final specification) and/or future versions and/or derivatives thereof, devices and/or networks operating in accordance with existing Wireless Fidelity (Wi-Fi) Alliance (WFA) Peer-to-Peer (P2P) specifications (Wi-Fi P2P technical specification, version 1.5, Aug. 4, 2014) and/or future versions and/or derivatives thereof, devices and/or networks operating in accordance with existing cellular specifications and/or protocols, e.g., 3rd Generation Partnership Project (3GPP), 3GPP Long Term Evolution (LTE) and/or future versions and/or derivatives thereof, devices and/or networks operating in accordance with existing Bluetooth (BT) specifications and/or protocols and/or future versions and/or derivatives thereof, units and/or devices which are part of the above networks, and the like.

Some embodiments may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some embodiments may be used in conjunction with one or more types of wireless communication signals and/or systems, for example, Radio Frequency (RF), Infra Red (IR), Frequency-Division Multiplexing (FDM), Orthogonal FDM (OFDM), Orthogonal Frequency-Division Multiple Access (OFDMA), FDM Time-Division Multiplexing (TDM), Time-Division Multiple Access (TDMA), Multi-User MIMO (MU-MIMO), Spatial Division Multiple Access (SDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™, Ultra-Wideband (UWB), Global System for Mobile communication (GSM), 2G, 2.5G, 3G, 3.5G, 4G, Fifth Generation (5G), or Sixth Generation (6G) mobile networks, 3GPP, Long Term Evolution (LTE), LTE advanced, Enhanced Data rates for GSM Evolution (EDGE), or the like. Other embodiments may be used in various other devices, systems and/or networks.

The term “wireless communication device”, as used herein, includes, for example, a device capable of causing wireless communication, a communication station capable of wireless communication, a portable or non-portable device capable of wireless communication, or the like. In some demonstrative embodiments, a wireless device may be or may include a peripheral that is integrated with a computer, or a peripheral that is attached to a computer. In some demonstrative embodiments, the term “wireless communication device” may optionally include a wireless service. Wireless communication devices or systems may include, for example, a UE, an MD, a STA, an AP, a PC, a desktop computer, a mobile computer, a laptop computer, an Ultrabook™ computer, a notebook computer, a tablet computer, a server computer, a handheld computer, an Internet of Things (IoT) device, a sensor device, a handheld device, a wearable device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “Carry Small Live Large” (CSLL) device, an Ultra Mobile Device (UMD), an Ultra Mobile PC (UMPC), a Mobile Internet Device (MID), an “Origami” device or computing device, a device that supports Dynamically Composable Computing (DCC), a context-aware device, a video device, an audio device, an A/V device, a Set-Top-Box (STB), a Blu-ray disc (BD) player, a BD recorder, a Digital Video Disc (DVD) player, a High Definition (HD) DVD player, a DVD recorder, a HD DVD recorder, a Personal Video Recorder (PVR), a broadcast HD receiver, a video source, an audio source, a video sink, an audio sink, a stereo tuner, a broadcast radio receiver, a flat panel display, a Personal Media Player (PMP), a digital video camera (DVC), a digital audio player, a speaker, an audio receiver, an audio amplifier, a gaming device, a data source, a data sink, a Digital Still camera (DSC), a media player, a Smartphone, a television, a music player, or the like.

The term “communicating” as used herein with respect to a communication signal includes transmitting the communication signal and/or receiving the communication signal. For example, a communication unit, which is capable of communicating a communication signal, may include a transmitter to transmit the communication signal to at least one other communication unit, and/or a communication receiver to receive the communication signal from at least one other communication unit. The verb communicating may be used to refer to the action of transmitting or the action of receiving. In one example, the phrase “communicating a signal” may refer to the action of transmitting the signal by a first device, and may not necessarily include the action of receiving the signal by a second device. In another example, the phrase “communicating a signal” may refer to the action of receiving the signal by a first device, and may not necessarily include the action of transmitting the signal by a second device.

As used herein, the term “circuitry” may refer to, be part of, or include, an Application Specific Integrated Circuit (ASIC), an integrated circuit, an electronic circuit, one or more processors (shared, dedicated, or group), and/or memory (shared, dedicated, or group), that execute one or more software or firmware programs, a combinational logic circuit, and/or other suitable hardware components that provide the described functionality. In some embodiments, the circuitry may be implemented in, or functions associated with the circuitry may be implemented by, one or more software or firmware modules. In some embodiments, circuitry may include logic, at least partially operable in hardware.

The term “logic” may refer, for example, to computing logic embedded in circuitry of a computing apparatus and/or computing logic stored in a memory of a computing apparatus. For example, the logic may be accessible by a processor of the computing apparatus to execute or implement the computing logic to perform computing functions and/or operations. In one example, logic may be embedded in various types of memory and/or firmware, e.g., silicon blocks of various chips and/or processors. Logic may be included in, and/or implemented as part of, various circuitry, e.g. radio circuitry, receiver circuitry, control circuitry, transmitter circuitry, transceiver circuitry, processor circuitry, and/or the like. In one example, logic may be embedded in volatile memory and/or non-volatile memory, including random access memory, read only memory, programmable memory, magnetic memory, flash memory, persistent memory, and the like. Logic may be executed by one or more processors using memory, e.g., registers, stuck, buffers, and/or the like, coupled to the one or more processors, e.g., as necessary to execute the logic.

Some demonstrative embodiments may be used in conjunction with a WLAN, e.g., a Wi-Fi network. Other embodiments may be used in conjunction with any other suitable wireless communication network, for example, a wireless area network, a “piconet”, a WPAN, a WVAN and the like.

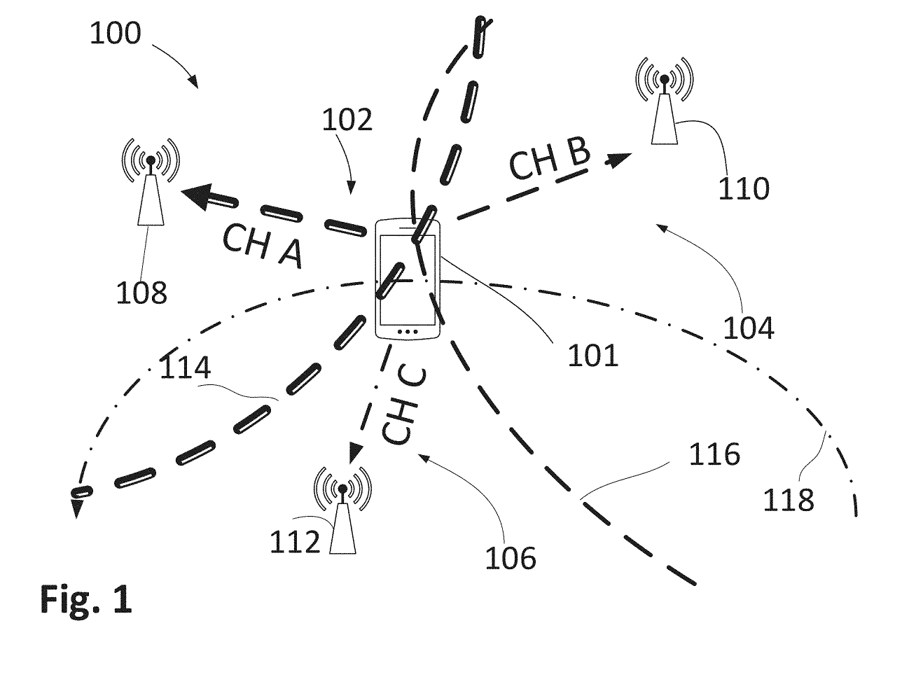

Reference is made to FIG. 1, which schematically illustrates a coordinated multiple AP environment 100 including first basic service set BSS 102, a second BSS 104, and a third BSS 106 in accordance with some demonstrative embodiments. As shown in FIG. 1, in some demonstrative embodiments, BSS 102 may include a wireless communication device in the form of a STA 101, and a wireless communication device in the form of AP 108. BSS 104 may include STA 101, and a wireless communication device in the form of AP 110. BSS 106 may include STA 101, and a wireless communication device in the form of AP 112. As shown in FIG. 1, there can be multiple APs operating in the environment 100, each within the range of STA 101, which would make the STA a CE STA, as it is within a range for overlapping coverage of APs 108, 110 and 112, at the respective “edges” of each BSS “cell” as indicated schematically be edges 114 and 116 and 118. In the examples provided hereinafter, there can be three or more APs operating on three channels, CH A, CH B and CH C, respectively, such as on three 20 MHz channels. The three channels may be contiguous or non-contiguous, and provide non-orthogonal multiple-access channels for wireless communication. Embodiments however encompass the use of one or more APs with which a STA may be associated, the use of different bandwidth channels, and/or the use of orthogonal frequency division multiple access (OFDMA) communication within each channel.

In the case of CE STAs, such as CE STA 101 of FIG. 1, such STAs can associate with multiple APs, for example with APs 108, 110 and 112 shown in FIG. 1. A CE STA therefore has the capability to operate on multiple contiguous or non-contiguous channels as between the APs with which it is associated, and can therefore access the medium for uplink or downlink data transmission as long as there is one available channel among the available channels, for example, in the case of FIG. 1, among CH A, CH B and CH C. For example, if CH A is busy, CH B and/or CH C may be idle, and accessible by a CE STA 101 for wireless communication. The capability of operating on multiple channels can advantageously improve the performance of a CE STA owing to higher channel access opportunities.

Referring still to FIG. 1, environment 100 may, according to one embodiment, employ a coordinated Multi-Point (CoMP) strategy, which provides joint precoding among coordinated APs, such as APs 108, 110 and 112, to mitigate the inter-cell interference. CoMP is considered as a solution to improve the performance of a CE STA. CoMP requires real-time, good quality channel state information (CSI) for the coordinated APs to do the joint precoding.

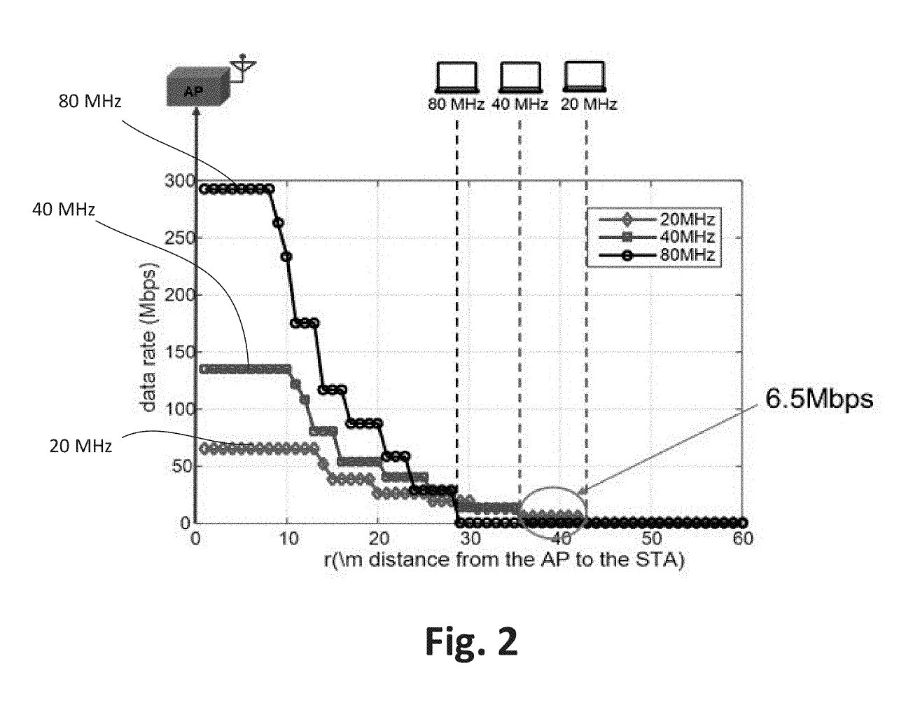

Considering the environment of FIG. 1, according to the state of the art, if for example the CE STA 101 were transmitting an uplink frame using CH A to AP 108, in order for CE STA 101 to switch from CH A to CH B within the environment, it would need to first finish transmitting the uplink frame on CH A before performing sensing on CH B and/or CH C, and performing a backoff procedure on CH B and/or CH C, such as a random backoff procedure according to an 802.11 protocol, in order to gain access to CH B and/or CH C. However, as noted in more detail with respect to FIG. 2 below, CE STA 101, by virtue of being a CE STA, can suffer from low-throughput performance as compared with its non-CE counterparts. Allowing the CE STA to be able to perform sensing on channels corresponding to the various APs with which it is associated while still engaged in an uplink transmission would improve its channel access capabilities and allow more efficient use of the wireless spectrum.

Referring next to FIG. 2, a graph is shown plotting physical data rate in Mbps for communication from an AP to a STA against the distance in meters between the AP and the STA for bandwidths of 20 MHz, 40 MHz and 80 MHz according to the IEEE 802.11ac protocol. As suggested in FIG. 2, a CE STA, as corroborated by shown data rates at the longer distances from the AP, can suffer from low-throughput performance compared to non-CE STAs mainly as a result of propagation loss, and as a result of interference from overlapping BSS′ transmissions. With respect to propagation loss, the supported physical data rate at a CE STA could be much lower than that of a non-CE STA. The above deleterious effect is even more pronounced with wider bandwidths, as compared with a deterioration in data rate going from 20 MHz to 40 MHz, and from 40 MHz to 80 MHz at the cell edge, as can be readily seen from the graph. In addition, to the extent that a CE STA may experience pronounced interference from overlapping BSS′ transmissions, such as, for example, CE STA 101 of FIG. 1 wishing to communicate on CH A, but experiencing interference from CH B and CH C, channel access opportunities of CE STAs tend to be much lower than that of non-CE STAs.

Advantageously, recent advances in self-interference cancellation (SIC) technologies involving antenna, analog radio frequency (RF) circuitries and digital signal processing enable simultaneous transmit (Tx) and receive (Rx) schemes on the same or adjacent frequency bands. SIC functionality would for example advantageously allow CE STA 101 to perform sensing on one or more of CH B and CH C to gain access to one of those channels while simultaneously transmitting an uplink frame on CH A.

Self-interference refers to an instance where a signal transmitted by a wireless communication device may be directly input to a receive antenna of the wireless communication device and this may cause self-interference. With SIC capability, a STA can continuously monitor the air medium in-band and/or adjacent band while transmitting frames, thus enabling better channel access capabilities and efficient use of the wireless spectrum, according to some demonstrative embodiments.

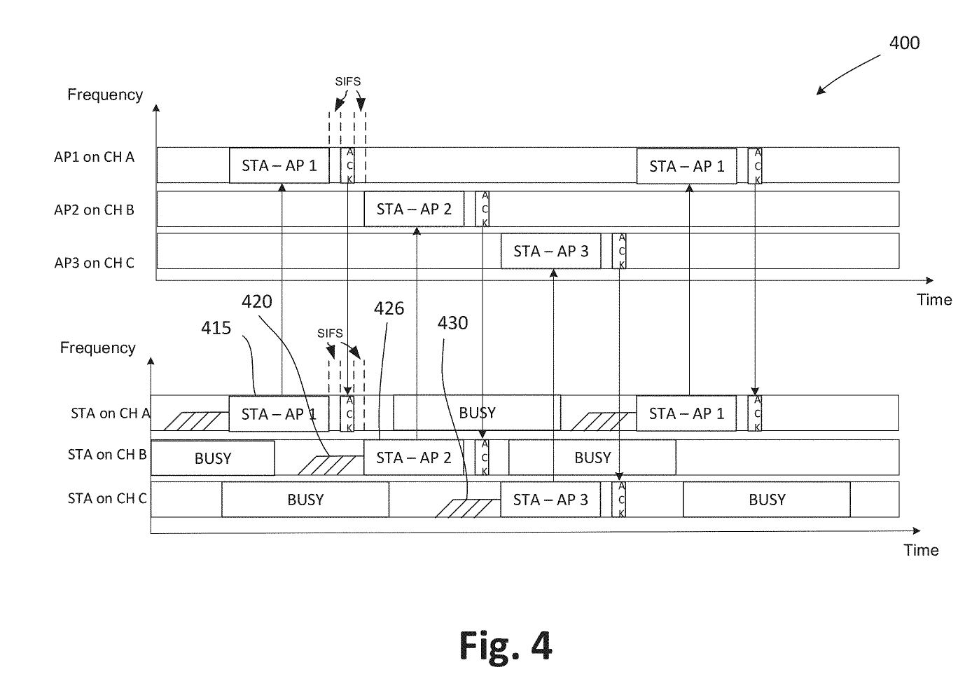

With respect to SIC, while a radio system may know the clean transmitted digital baseband signal, once the signal is converted to analog and up-converted to the right carrier frequency, the transmitted signal looks quite different from its baseband incarnation. The numerous analog components in the radio system transmit chain can for example distort the signal in both linear and nonlinear ways, add their own noise, may be slightly inaccurate, or introduce delay by different amounts at different frequencies. The transmitted signal would therefore be a complicated nonlinear function of the ideal transmitted signal along with unknown noise. Therefore, subtracting a known baseband version of the transmit signal without accounting for all these analog distortions would not be sufficient. The goal of a SIC architecture could be to model and predict these distortions such that it can compensate for them at the receiver, as would be recognized by one skilled in the art. Examples of operation of a wireless apparatus using SIC in order to gain access to channels while transmitting an uplink frame will be provided further below with respect to FIG. 4.

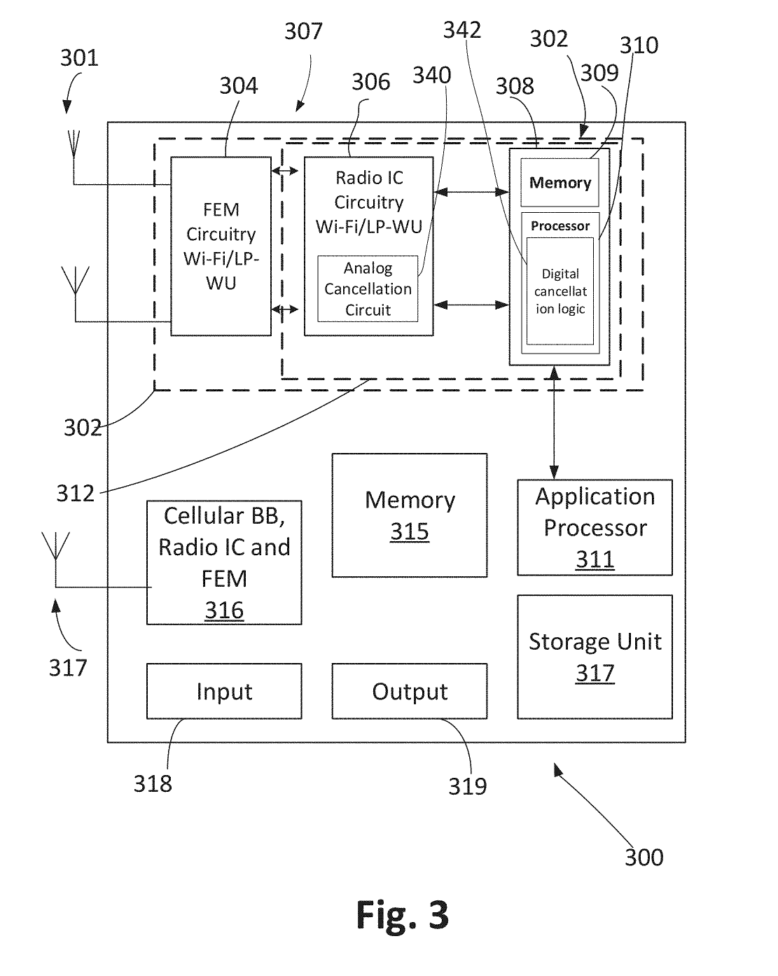

Reference will now be made to FIG. 3, which depicts one embodiment of a wireless communication system 300 such as STA 101 or any of APs 108, 110 or 112 of FIG. 1. The wireless communication system 300 may include radio system 302. Radio system 302 may include radio front-end module (FEM) circuitry 304, radio integrated circuit (radio IC) 306 and baseband processor or processing circuitry 308. The radio IC 306 and baseband processor 308 may be positioned on the same integrated circuit card (IC) 312, although embodiments are not so limited. The radio IC 306 and FEM circuitry 304 may together be referred to as a transceiver system 307, and it is to be understood that radio IC 306 and FEM circuitry 304 may, in one embodiment, have their functionality integrated, although embodiments are not so limited. The wireless communication system 300 as shown may further include both Wi-Fi functionality and LP-WU (Low Power Wake-up) functionality, although embodiments are not so limited. LP-WUR (Low Power Wake-up Radio)/LP-WU may refer to Medium Access Control Layer and Physical Layer specifications in accordance with efforts within the Institute of Electrical and Electronics Engineers (IEEE)'s regarding a LP-WUR standard/802.11ba standard.

In FIG. 3, it is further to be noted that the representation of a single antenna may be interpreted to mean one or more antennas. Also, as used herein, “processing circuitry” or “processor” may include one or more distinctly identifiable processor blocks.

The FEM circuitry 304 may include a receive signal path comprising circuitry configured to operate on Wi-Fi signals received from one or more antennas 301, to amplify the received signals and to provide the amplified versions of the received signals to the radio IC 306 for further processing. FEM circuitry 304 may also include a transmit signal path which may include circuitry configured to amplify Wi-Fi signals provided by the radio IC 306 for wireless transmission by one or more of the antennas 301. The antennas may include directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result.

Radio IC 306 as shown may include a receive signal path which may include circuitry to down-convert signals received from the FEM circuitry 304 and provide baseband signals to baseband processor 308. The radio IC 306 may also include a transmit signal path which may include circuitry to up-convert baseband signals provided by the baseband processor 308 and provide RF output signals to the FEM circuitry 304 for subsequent wireless transmission by the one or more antennas 301. In addition, for a SIC capable STA or AP, radio IC 306 may include analog cancellation circuitry 340. A role of the analog cancellation circuitry 340 is to prevent receiver saturation, by sufficiently cancelling the self-interference signal in analog before the self-interference signal arrives at the low-noise amplifier (LNA) of the FEM circuitry. An analog cancellation circuitry to prevent saturation at the receiver is not limited to one necessarily incorporated into the FEM circuitry 304, and its implementation may span from a discrete board-level solution to a multi-chip module (MCM) to a single die radio frequency integrated circuit (RFIC) coupled to the IC 312.

Baseband processing circuitry 308 may include a memory 309, such as, for example, a set of RAM arrays in a Fast Fourier Transform or Inverse Fast Fourier Transform block (not shown) of the baseband processor 308. Processing circuitry 310, may include control logic to process the signals received from the receive signal path of the radio IC 306. Baseband processing circuitry 308 may also include control logic to generate baseband signals for the transmit signal path of the radio IC 306. Processing circuitry 310 may further include physical layer (PHY) and medium access control layer (MAC) circuitry (not shown), and may further interface with application processor 311 for generation and processing of the baseband signals and for controlling operations of the radio IC 306. Baseband processing circuitry may also include digital cancellation logic 342 to provide part of the SIC functionality, including digital cancellation on the digital baseband IQ samples, as would be recognized by one skilled in the art.

In some demonstrative embodiments, the FEM circuitry 304, the radio IC 306, and baseband processor 308 may be provided on a single radio card, such as radio system 302. In some other embodiments, the one or more antennas 301, the FEM circuitry 304 and the radio IC 306 may be provided on a single radio card. In some other embodiments, the radio IC 306 and the baseband processor 308 may be provided on a single chip or integrated circuit (IC), such as IC 312.

In some demonstrative embodiments, the wireless communication system 300 of FIG. 3 may include a Wi-Fi radio system and may be configured for Wi-Fi communications, and/or may have a cellular radio system and may be configured for cellular communications, although the scope of the embodiments is not limited in this respect. In some other embodiments, the wireless communication system 300 may be configured to transmit and receive signals transmitted using one or more modulation techniques other than OFDM or OFDMA, such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, and On-Off Keying (OOK), although the scope of the embodiments is not limited in this respect. In some demonstrative embodiments, the wireless communication system 300 may include other radio systems, such as a cellular radio system 316 configured for cellular (e.g., 3GPP such as LTE, LTE-Advanced or 5G communications).

In some IEEE 802.11 embodiments, the wireless communication system 300 may be configured for communication over various channel bandwidths including bandwidths having center frequencies of 900 MHz, 2.03125 MHz, 2.4 GHz, 4.0625 MHz, 5 GHz, 8.28125 MHz and bandwidths of less than 5 MHz, or of about 1 MHz, 2 MHz, 2.5 MHz, 4 MHz, 5 MHz, 8 MHz, 10 MHz, 16 MHz, 20 MHz, 40 MHz, 80 MHz (with contiguous bandwidths) or 80+80 MHz (160 MHz) (with non-contiguous bandwidths), or any combination of the above frequencies or bandwidths, or any frequencies or bandwidths between the ones expressly noted above. In some demonstrative embodiments, a 320 MHz channel bandwidth may be used. The scope of the embodiments is not limited with respect to the above center frequencies however.

Referring still to FIG. 3, in some demonstrative embodiments, wireless communication system 300 may further include an input unit 318, an output unit 319, a memory unit 315. Wireless communication system 300 may optionally include other suitable hardware components and/or software components. In some demonstrative embodiments, some or all of the components of wireless communication system 300 may be enclosed in a common housing or packaging, and may be interconnected or operably associated using one or more wired or wireless links. In other embodiments, components of wireless communication system 300 may be distributed among multiple or separate devices.

In some demonstrative embodiments, application processor 311 may include, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Application processor 311 may execute instructions, for example, of an Operating System (OS) of wireless communication system 300 and/or of one or more suitable applications.

In some demonstrative embodiments, input unit 318 may include, for example, one or more input pins on a circuit board, a keyboard, a keypad, a mouse, a touch-screen, a touch-pad, a track-ball, a stylus, a microphone, or other suitable pointing device or input device. Output unit 319 may include, for example, one or more output pins on a circuit board, a monitor, a screen, a touch-screen, a flat panel display, a Light Emitting Diode (LED) display unit, a Liquid Crystal Display (LCD) display unit, a plasma display unit, one or more audio speakers or earphones, or other suitable output devices.

In some demonstrative embodiments, memory 315 may include, for example, a Random-Access Memory (RAM), a Read-Only Memory (ROM), a Dynamic RAM (DRAM), a Synchronous DRAM (SD-RAM), a flash memory, a volatile memory, a non-volatile memory, a cache memory, a buffer, a short-term memory unit, a long-term memory unit, or other suitable memory units.

Storage unit 317 may include, for example, a hard disk drive, a floppy disk drive, a Compact Disk (CD) drive, a CD-ROM drive, a DVD drive, or other suitable removable or non-removable storage units. Memory unit 315 and/or storage unit 317, for example, may store data processed by wireless communication system 300.

In some demonstrative embodiments, some or all of the components of wireless communication system 300 of FIG. 3 may be enclosed in a common housing or packaging, and may be interconnected or operably associated using one or more wired or wireless links. In other embodiments, components wireless communication system 300 may be distributed among multiple or separate devices.

In some demonstrative embodiments, STA 101, AP 108, AP 110 and AP 112 may be configured to implement one or more Multi-User (MU) mechanisms, such as MU Multiple-Input Multiple-Output (MU-MIMO) mechanisms. For example, devices 102 and/or 140 may be configured to implement one or more MU mechanisms, which may be configured to enable MU communication of Downlink (DL) frames using a Multiple-Input-Multiple-Output (MIMO) scheme, for example, between a device, e.g., device 102, and a plurality of devices, e.g., including device 140 and/or one or more other devices.

In some demonstrative embodiments, the link access overhead may be based an acknowledgment mechanism, which may be an integral part of a carrier sense multiple access (CSMA) with collision avoidance (CA) (CSMA/CA) mechanism, which may be implemented at the MAC layer.

Referring next to FIG. 4, which is a signaling diagram of some demonstrative embodiments of communications from a STA, such as STA 101 of FIG. 1, to three APs, AP1, AP2 and AP3, such as APs 108, 110 and 112 of FIG. 1, on respective channels CH A, CH B and CH C as also depicted in FIG. 1. It is to be noted that, regardless of FIG. 4, embodiments encompass operations at a STA, such as a CE STA, with access to any number of channels and APs. Referring back to FIG. 4, the top and bottom portions of the figure depict a signaling diagram for the STA and three APs showing frequency versus time, with the shown frequency bands corresponding to respective ones of CH A, CH B and CH C. The top of the figure shows a signaling diagram for AP1, AP2 and AP3 communicating with the STA, and the bottom of the figure shows a signaling diagram for the STA communicating with respective ones of the three APs, with communication happening between the STA and the three APs as shown by the arrows between the top portion and the bottom portion of the figure. FIG. 4 depicts a series of uplink frames from the STA to respective ones of the APs, in the form of STA-AP1 to AP1, STA-AP2 to AP2 and STA-AP3 to AP3, and a series of corresponding downlink acknowledgment frames (ACKs) from the respective APs to the STA. The ACKs may be separated from the uplink frame that they acknowledge by a short interframe space SIFS as shown, although embodiments are not so limited. Each shown uplink frame is shown as being preceded by a backoff period, such as a random backoff period or an exponential backoff period as selected based on known WLAN/802.11 carrier sense multiple access (CSMA) with collision avoidance (CA) backoff mechanisms, as would recognized by one skilled in the art.

Referring still to FIG. 4, according to some demonstrative embodiments, during transmission of a first uplink frame STA-AP1/415 from the STA to AP1, the STA starts sensing channels for the APs with which it is associated, in this case CH B and CH C. “Sensing” here may include physical carrier sense (CCA) and virtual carrier sense (NAV) to determine whether a sensed channel is busy or idle. However, “sensing” may include any sensing of the channel to allow a determination as to whether the channel is busy or idle. Having sensed CH C busy, the STA is then shown as initiating a backoff procedure 420 on CH B, and decrementing the backoff counter. Since, as shown, CH B is still idle at the end of the backoff period and after the first uplink frame STA-AP1/415 has been transmitted and its associated ACK received, the STA switches to CH B, and transmits/sends a second uplink frame STA-AP 2/426 to AP2 on CH B. This process is shown as replicating itself across time as shown in the signaling diagram, for example with the STA, while transmitting the second uplink frame STA-AP2/426 as sensing the channels again, determining CH A is busy, and initiating a backoff procedure 430 before switching to CH C and transmitting a third uplink frame STA-AP3/436 to AP3. Embodiments are however not limited to the signaling sequence shown in FIG. 4, and encompass a signaling sequence where a STA, such as a CE STA, senses one or more channels and starts a backoff period on at least one channel while engaged in transmitting an uplink frame on another channel.

Reference will now be made to FIGS. 1, 3, and 4 in order to describe some demonstrative embodiments.

According to some demonstrative embodiments, a wireless communication device, such as, for example, baseband processing circuitry 308 of FIG. 3, comprises a memory and processing circuitry. The memory may for example correspond to baseband memory 309, and the processing circuitry may correspond to processing circuitry 310 in FIG. 3. However, embodiments are not so limited. For example, embodiments encompass within their scope a wireless communication device that may correspond to a wireless communication system such as wireless communication system 300 of FIG. 3 or to STA 101 of FIG. 1, including any one of the memories or processing circuitries therein capable of performing the below functions.

The processing circuitry, according to some demonstrative embodiments, is to cause transmission of a first uplink frame, such as frame STA-AP1/415 of FIG. 4, on a first channel, such as on CH A of FIG. 4. Furthermore, while causing transmission of the first uplink frame, the processing circuitry is to perform channel sensing on a second channel, such as on CH B of FIG. 4 to determine a busy or an idle status of the second channel. In response to a determination of an idle status for the second channel, the processing circuitry is to then perform a backoff procedure, such as backoff procedure 420 of FIG. 4, such as a random backoff procedure, to gain access to the second channel. In addition, in response to a determination that the second channel still has an idle status after completion of the backoff procedure and after completion of the transmission of the first uplink frame, and for example after reception of an ACK for the first uplink frame, the processing circuitry is to cause a switch to the second channel and to cause transmission of a second uplink frame, such as second uplink frame 426 of FIG. 4, on the second channel, such as CH B.

According to some demonstrative embodiments, the device may be configured to implement self-interference cancellation (SIC) functionality to perform the channel sensing while causing transmission of the first uplink frame.

A processing circuitry according to some demonstrative embodiments, if the second channel is sensed busy during transmission of the first uplink frame on the first channel, may be configured to perform channel sensing on one or more channels. For example, in the case of FIG. 4, while transmitting first uplink frame STA-AP1/415, in response to a determination that CH B has a busy status after sensing CH B, the STA can perform channel sensing on CH C to determine a busy or an idle status of CH C. Then, in response to a determination of an idle status for CH C, the STA can perform a backoff procedure to gain access to CH C. Then, in response to a determination that CH C has an idle status after completion of the backoff procedure and after completion of the transmission of the first uplink frame STA-AP1/415 and optionally after reception of the ACK associated therewith, the processing circuitry is configured to cause a switch to CH C, and to cause transmission of a second uplink frame on CH C.

According to some demonstrative embodiments, there could be an instance where the second channel, such as CH B, has a busy status after completion of the first backoff procedure and after completion of the transmission of the first uplink frame and optionally after reception of the ACK associated therewith. In such an instance, the processing circuitry may be configured to perform channel sensing on one or more channels, such as CH A and CH C. In this way, the processing circuitry may determine a busy or an idle status of the one or more channels. Then, in response to a determination that one of the one or more channels has an idle status, such as CH C, the processing circuitry may be configured perform a second backoff procedure (different from the second backoff procedure 430 of FIG. 4 because it would be taking place based on CH B being busy after the first backoff procedure). In this way, the processing circuitry may gain access to CH C, then cause a switch to CH C, and cause transmission of the second uplink frame on CH C.

According to some demonstrative embodiments, the processing circuitry in response to a determination that, after completion of the transmission of the first uplink frame and optionally after reception of the ACK associated therewith, the second channel, such as CH B, has a busy status and did not have an idle status during transmission of the first uplink frame, is configured to update channel occupancy data regarding the second channel to reflect unavailability of the second channel during the transmission of the first uplink frame. For example, the processing circuitry may perform such update by storing channel data information on each channel, such as, in this instance, CH B, in a memory, such as for example in memory 309 or 315 of FIG. 3, and later accessing such information when making a determination regarding which channels to sense for subsequent uplink frame transmissions. For example, according to some demonstrative embodiments, the processing circuitry is further to select the second channel as a target channel from one or more channels for channel sensing based on the second channel having a lowest average channel occupancy of one or more channels that have been the subject of sensing. The processing circuitry may further choose a number of channels with lowest average channel occupancies from a larger number of channels.

According to some demonstrative embodiments, the processing circuitry, while causing transmission of the first uplink frame, may perform channel sensing on one or more channels to determine a busy or an idle status of the one or more channels, the one or more channels including the second channel. For example, the processing circuitry of the STA in FIG. 4, may perform channel sensing on not only CH B, but also on CH C, while transmitting an uplink frame on CH A, as noted previously with respect to FIG. 4. Where the one or more channels include a plurality of channels, and one or more of the plurality of channels is found to be idle, the processing circuitry may be configured to perform simultaneous backoff procedures for each of the one of more of the plurality of channels to gain access to one available channel In such a case, the processing circuitry may determine which channel is the earliest channel of the one of more of the plurality of channels to have an idle status after completion the backoff procedure pertaining to that channel and after completion of the transmission of the first uplink frame, cause a switch to the earliest channel and cause transmission of the second uplink frame and optionally after reception of the ACK associated therewith on the earliest channel. The plurality of channels in this demonstrative embodiment may be contiguous or non-contiguous. If the channels are non-contiguous, the STA would need to operate on a wide channel bandwidth, leading to higher power consumption. In such a case, the STA may determine, based on the sensing power requirements, whether its sensing strategy should include multi-channel sensing, and if yes, to for which channels and to what extent.

According to some demonstrative embodiments, the processing circuitry may be configured to indicate the intended switch to the second channel to the AP to which it is sending the first uplink frame, such as to AP 1 in FIG. 4, by using a field in the first uplink frame prior to receiving a downlink acknowledgment (ACK) from AP 1 for the uplink frame. An uplink fame from the STA may contain aggregate medium access protocol data units (A-MPDUs), and each of the A-MPDU's may include a delimiter field including a reserved/indication bit. While the first uplink frame is being transmitted to the AP, the processing circuitry may, according to some embodiments, set the indication bit in a delimiter field of one of the A-MPDUs of the first uplink frame addressed to the AP. The indication bit could be set to include information regarding a fact of the STA's intention to switch to another channel, for example from CH A to CH B. In that case, the AP may refrain from sending downlink frames to the STA, such as an ACK or other downlink frame, until the STA is back on the channel to communicate with the AP. The AP would have information regarding resurfacing of the STA on its associated channel for example through a frame such as a probe request frame sent on that channel by the STA. In the alternative, while transmitting the first uplink frame, the STA could indicate to the AP the duration of time before it returns to that same channel According to one embodiment, the STA may, at a time of sending the indication in the delimiter field of the A-MPDU, send busy tones and/or duplicate frames corresponding to the first uplink A-MPDUs being sent on the channel it intends to switch to, such as on CH B, in order to reserve the channel before making the switch.

The device according to some demonstrative embodiments, such as the wireless communication device described above, may include a wireless communication system further including a baseband processing circuitry, such as, for example, baseband processing circuitry 308 of FIG. 3, the system including the memory, such as, for example memory 309 or memory 315, and the processing circuitry, such as, for example, processing circuitry 310 or application processor 311, a radio integrated circuit, such as, for example, radio IC 306 coupled to the baseband processing circuitry, and a front-end module, such as, for example, FEM circuitry 304 coupled to the radio integrated circuitry. The system may further include digital cancellation logic and analog cancellation circuitry to provide the SIC functionality, such as, for example, digital cancellation logic 342 and analog cancellation circuit 340 of FIG. 3. The system may further include a plurality of antennas coupled to the radio IC circuitry, such as antennas 301.

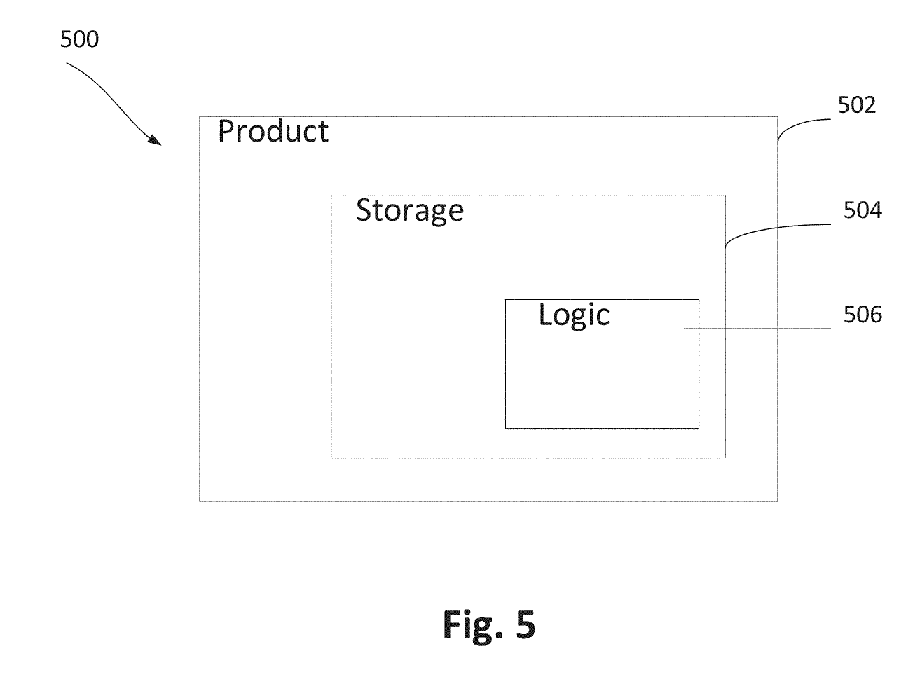

FIG. 5 illustrates a product of manufacture 500, in accordance with some demonstrative embodiments. Product 500 may include one or more tangible computer-readable non-transitory storage media 502, which may include computer-executable instructions, e.g., implemented by logic 504, operable to, when executed by at least one computer processor, cause the at least one computer processor to implement one or more operations at a STA or an AP, and/or to perform one or more operations described above with respect to FIGS. 1, 3 and 4, and/or one or more operations described herein. The phrase “non-transitory machine-readable medium” is directed to include all computer-readable media, with the sole exception being a transitory propagating signal.

In some demonstrative embodiments, product 500 and/or storage media 502 may include one or more types of computer-readable storage media capable of storing data, including volatile memory, non-volatile memory, removable or non-removable memory, erasable or non-erasable memory, writeable or re-writeable memory, and the like. For example, storage media 502 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), Compact Disk ROM (CD-ROM), Compact Disk Recordable (CD-R), Compact Disk Rewriteable (CD-RW), flash memory (e.g., NOR or NAND flash memory), content addressable memory (CAM), polymer memory, phase-change memory, ferroelectric memory, silicon-oxide-nitride-oxide-silicon (SONOS) memory, a disk, a floppy disk, a hard drive, an optical disk, a magnetic disk, a card, a magnetic card, an optical card, a tape, a cassette, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative embodiments, logic 504 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative embodiments, logic 504 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, such as C, C++, Java, BASIC, Matlab, Pascal, Visual BASIC, assembly language, machine code, and the like.

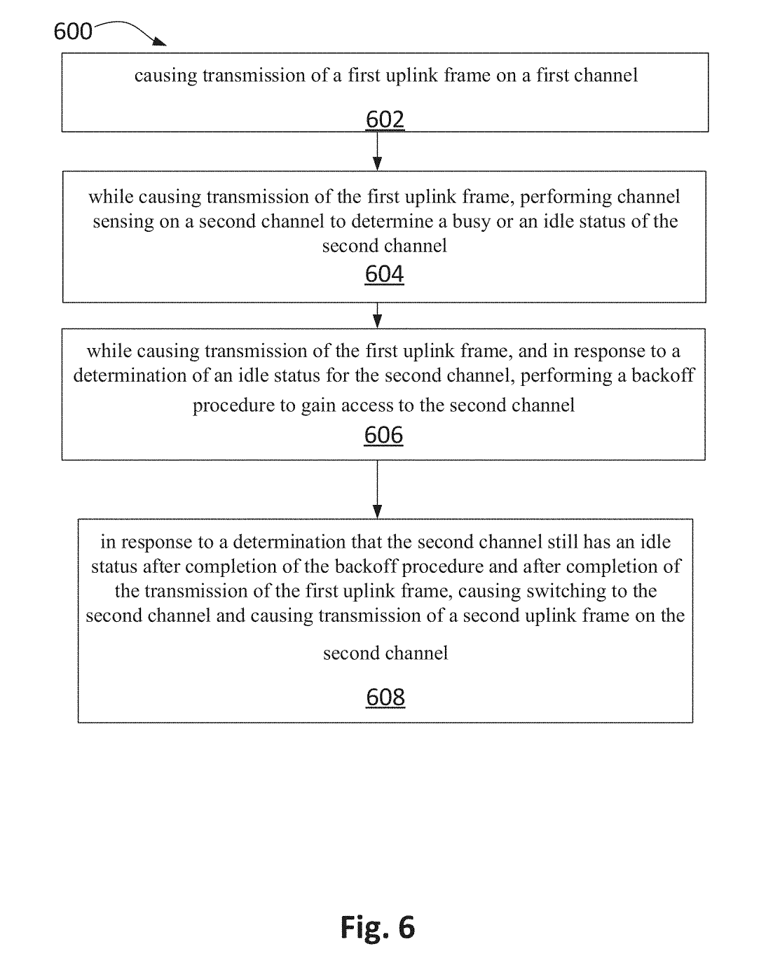

FIG. 6 illustrates a method 600 of using a wireless communication device in accordance with some demonstrative embodiments. The method 600 may begin with operation 602, which includes causing transmission of a first uplink frame on a first channel. At operation 604, the method may include, while causing transmission of the first uplink frame, performing channel sensing on a second channel to determine a busy or an idle status of the second channel. At operation 406, the method may include, while causing transmission of the first uplink frame, and in response to a determination of an idle status for the second channel, performing a backoff procedure to gain access to the second channel. At operation 608, the method may include, in response to a determination that the second channel still has an idle status after completion of the backoff procedure and after completion of the transmission of the first uplink frame, causing switching to the second channel and causing transmission of a second uplink frame on the second channel.

Some demonstrative embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. Those instructions may then be read and executed by one or more processors to cause the wireless communication system of FIG. 3 to perform the methods and/or operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

### EXAMPLES

The following examples pertain to further embodiments.

Example 1 includes a wireless communication device comprising a memory and processing circuitry, the processing circuitry including logic to: cause transmission of a first uplink frame on a first channel; while causing transmission of the first uplink frame: perform channel sensing on a second channel to determine a busy or an idle status of the second channel; in response to a determination of an idle status for the second channel, perform a backoff procedure to gain access to the second channel; and, in response to a determination that the second channel still has an idle status after completion of the backoff procedure and after completion of the transmission of the first uplink frame, cause a switch to the second channel and cause transmission of a second uplink frame on the second channel.

Example 1 includes the subject matter of Example 1, and optionally, wherein the backoff procedure is a first backoff procedure, the processing circuitry further to: while causing transmission of the first uplink frame and in response to a determination that the second channel has a busy status: perform channel sensing on one or more channels to determine a busy or an idle status of the one or more channels; and in response to a determination of an idle status for one of the one or more channels, perform a second backoff procedure to gain access to the one of the one or more channels; and in response to a determination that one of the one or more channels has an idle status after completion of the second backoff procedure and after completion of the transmission of the first uplink frame, cause a switch to the one of the one or more channels and cause transmission of a second uplink frame on the one of the one or more channels.

Example 3 includes the subject matter of Example 1, and optionally, wherein the backoff procedure is a first backoff procedure, the processing circuitry further to, in response to a determination that the second channel has a busy status and after completion of the first backoff procedure and after completion of the transmission of the first uplink frame: perform channel sensing on one or more channels to determine a busy or an idle status of the one or more channels; in response to a determination that one of the one or more channels has an idle status, perform a second backoff procedure to gain access to the one of the one or more channels, cause a switch to the one of the one or more channels, and cause transmission of the second uplink frame on the one of the one or more channels.

Example 4 includes the subject matter of any one of Examples 1-3, and optionally, wherein the processing circuitry is further to, in response to a determination that, after completion of the transmission of the first uplink frame, the second channel has a busy status and did not have an idle status during transmission of the first uplink frame: update channel occupancy data on the second channel to reflect unavailability of the second channel during the transmission of the first uplink frame; and cause transmission of subsequent uplink frames based on the channel occupancy data.

Example 5 includes the subject matter of Example 3, and optionally, wherein the one or more channels include at least one of the first channel and the second channel.

Example 6 includes the subject matter of Example 1, and optionally, wherein the processing circuitry is further to, while causing transmission of the first uplink frame, perform channel sensing on one or more channels to determine a busy or an idle status of the one or more channels, the one or more channels including the second channel.

Example 7 includes the subject matter of any one of Examples 1, 2, 3, 5 and 6, and optionally, wherein the processing circuitry is further to select the second channel as a target channel from one or more channels for channel sensing based on the second channel having a lowest average channel occupancy of the one or more channels.

Example 8 includes the subject matter of any one of examples 2, 3, 5 and 6, and optionally, wherein the processing circuitry is further to indicate to an access point to which the first uplink frame is addressed the switch to the second channel by using a field in the second uplink frame.

Example 9 includes the subject matter of Example 6, and optionally, wherein the one or more channels includes a plurality of channels, the processing circuitry further to: while causing transmission of the first uplink frame, and in response to a determination of an idle status for one or more of the plurality of channels, the one or more of the plurality of channels including the second channel, simultaneously perform a backoff procedure for each of the one or more of the plurality of channels to gain access to the one or more of the plurality of channels; and in response to a determination that the second channel is an earliest channel of the one or more of the plurality of channels to have an idle status after completion the backoff procedure pertaining to the second channel and after completion of the transmission of the first uplink frame, cause a switch to the second channel and cause transmission of the second uplink frame on the second channel.

Example 10 includes the subject matter of Example 9, and optionally, wherein the plurality of channels is contiguous.

Example 11 includes the subject matter of any one of Examples 1, 2, 3, 5, 6, 9 and 10, and optionally, wherein the device is configured to implement self-interference cancellation (SIC) functionality to perform the channel sensing while causing transmission of the first uplink frame.

Example 12 includes the subject matter of Example 11, and optionally, the device comprising a wireless communication system further including a baseband processing circuitry including the memory and the processing circuitry, a radio integrated circuit coupled to the baseband processing circuitry, and a front-end module coupled to the radio integrated circuit.

Example 13 includes the subject matter of Example 12, and optionally, further including digital cancellation logic and analog cancellation circuitry to provide the SIC functionality.

Example 14 includes the subject matter of Example 13, and optionally, and optionally wherein the baseband processing circuitry includes the digital cancellation logic, and the radio integrated circuit includes the analog cancellation circuitry.

Example 15 includes the subject matter of Example 14, and optionally, further including a plurality of antennas coupled to the radio IC circuitry.

Example 16 includes a product comprising one or more tangible computer-readable non-transitory storage media comprising computer-executable instructions operable to, when executed by at least one computer processor, cause the at least one computer processor to implement operations at a wireless communication device, the operations comprising: causing transmission of a first uplink frame on a first channel; while causing transmission of the first uplink frame: performing channel sensing on a second channel to determine a busy or an idle status of the second channel; in response to a determination of an idle status for the second channel, performing a backoff procedure to gain access to the second channel; in response to a determination that the second channel still has an idle status after completion of the backoff procedure and after completion of the transmission of the first uplink frame, causing switching to the second channel and causing transmission of a second uplink frame on the second channel.

Example 17 includes the subject matter of Example 16, and optionally, wherein the backoff procedure is a first backoff procedure, the method further comprising: while causing transmission of the first uplink frame and in response to a determination that the second channel has a busy status: performing channel sensing on one or more channels to determine a busy or an idle status of the one or more channels; and in response to a determination of an idle status for one of the one or more channels, performing a second backoff procedure to gain access to the one of the one or more channels; in response to a determination that one of the one or more channels has an idle status after completion of the second backoff procedure and after completion of the transmission of the first uplink frame, causing switching to the one of the one or more channels and causing transmission of a second uplink frame on the one of the one or more channels.

Example 18 includes the subject matter of Example 16, and optionally, wherein the backoff procedure is a first backoff procedure, the operations further including, in response to a determination that the second channel has a busy status and after completion of the first backoff procedure and after completion of the transmission of the first uplink frame: performing channel sensing on one or more channels to determine a busy or an idle status of the one or more channels; and in response to a determination that one of the one or more channels has an idle status, performing a second backoff procedure to gain access to the one of the one or more channels, causing switching to the one of the one or more channels, and causing transmission of the second uplink frame on the one of the one or more channels.

Example 19 includes the subject matter of any one of Examples 16 and 18, the operations further including, in response to a determination that, after completion of the transmission of the first uplink frame, the second channel has a busy status and did not have an idle status during the transmission of the first uplink frame: updating channel occupancy data on the second channel to reflect unavailability of the second channel during the transmission of the first uplink frame; and causing transmission of subsequent uplink frames based on the channel occupancy data.

Example 20 includes the subject matter of Example 18, and optionally, wherein the one or more channels include the second channel.

Example 21 includes the subject matter of Example 16, and optionally, wherein the operations further include, while causing transmission of the first uplink frame, performing channel sensing on one or more channels to determine a busy or an idle status of the one or more channels, the one or more channels including the second channel.

Example 22 includes the subject matter of any one of Examples 16, 17, 18, 20 and 21, wherein the operations further include selecting the second channel as a target channel from one or more channels for channel sensing based on the second channel having a lowest average channel occupancy of the one or more channels.

Example 23 includes the subject matter of any one of Examples 16, 17, 18, 20 and 21, wherein the operations further include indicating to the AP the switch to the second channel by using a field in the second uplink frame.

Example 24 includes the subject matter of Example 21, and optionally, wherein the one or more channels includes a plurality of channels, the operations further including: while causing transmission of the first uplink frame, and in response to a determination of an idle status for one or more of the plurality of channels, the one or more of the plurality of channels including the second channel, simultaneously performing a backoff procedure for each of the one or more of the plurality of channels to gain access to the one or more of the plurality of channels; in response to a determination that the second channel is an earliest channel of the one or more of the plurality of channels to have an idle status after completion the backoff procedure pertaining to the second channel and after completion of the transmission of the first uplink frame, causing switching to the second channel and causing transmission of the second uplink frame on the second channel.

Example 25 includes the subject matter of Example 24, and optionally, wherein the plurality of channels is contiguous.

Example 26 includes the subject matter of any one of Examples 16, 17, 18, 20, 21, 24 and 25, wherein the operations include using self-interference cancellation (SIC) functionality to perform the channel sensing while causing transmission of the first uplink frame.

Example 27 includes the subject matter of Example 26, and optionally, the operations further including using digital cancellation logic and an analog cancellation circuitry to provide the SIC functionality.

Example 28 includes a method of operating a wireless communication device, the method comprising: causing transmission of a first uplink frame on a first channel; while causing transmission of the first uplink frame: performing channel sensing on a second channel to determine a busy or an idle status of the second channel; in response to a determination of an idle status for the second channel, performing a backoff procedure to gain access to the second channel; and in response to a determination that the second channel still has an idle status after completion of the backoff procedure and after completion of the transmission of the first uplink frame, causing switching to the second channel and causing transmission of a second uplink frame on the second channel.

Example 29 includes the method of Example 28, and optionally, wherein the backoff procedure is a first backoff procedure, the method further comprising: while causing transmission of the first uplink frame and in response to a determination that the second channel has a busy status: performing channel sensing on one or more channels to determine a busy or an idle status of the one or more channels; and in response to a determination of an idle status for one of the one or more channels, performing a second backoff procedure to gain access to the one of the one or more channels; in response to a determination that one of the one or more channels has an idle status after completion of the second backoff procedure and after completion of the transmission of the first uplink frame, causing switching to the one of the one or more channels and causing transmission of a second uplink frame on the one of the one or more channels.

Example 30 includes the method of Example 28, and optionally, wherein the backoff procedure is a first backoff procedure, the method further comprising, in response to a determination that the second channel has a busy status and after completion of the first backoff procedure and after completion of the transmission of the first uplink frame: performing channel sensing on one or more channels to determine a busy or an idle status of the one or more channels; and in response to a determination that one of the one or more channels has an idle status, performing a second backoff procedure to gain access to the one of the one or more channels, causing switching to the one of the one or more channels, and causing transmission of the second uplink frame on the one of the one or more channels.

Example 31 includes the subject matter of any one of Examples 28 and 30, and optionally, the method further comprising, in response to a determination that, after completion of the transmission of the first uplink frame, the second channel has a busy status and did not have an idle status during the transmission of the first uplink frame: updating channel occupancy data on the second channel to reflect unavailability of the second channel during the transmission of the first uplink frame; and causing transmission of subsequent uplink frames based on the channel occupancy data.

Example 32 includes the method of Example 30, and optionally, wherein the one or more channels include the second channel.

Example 33 includes the method of Example 28, and optionally, wherein the method further comprises, while causing transmission of the first uplink frame, performing channel sensing on one or more channels to determine a busy or an idle status of the one or more channels, the one or more channels including the second channel.

Example 34 includes the subject matter of any one of Examples 28-29 and 32-33, and optionally, wherein the method further comprises selecting the second channel as a target channel from one or more channels for channel sensing based on the second channel having a lowest average channel occupancy of the one or more channels.

Example 35 includes the method of Example 28, and optionally, wherein the method further comprises indicating to the AP the switch to the second channel by using a field in the second uplink frame.

Example 36 includes the method of Example 21, and optionally, wherein the one or more channels includes a plurality of channels, the method further comprising: while causing transmission of the first uplink frame, and in response to a determination of an idle status for one or more of the plurality of channels, the one or more of the plurality of channels including the second channel, simultaneously performing a backoff procedure for each of the one or more of the plurality of channels to gain access to the one or more of the plurality of channels; in response to a determination that the second channel is an earliest channel of the one or more of the plurality of channels to have an idle status after completion the backoff procedure pertaining to the second channel and after completion of the transmission of the first uplink frame, causing switching to the second channel and causing transmission of the second uplink frame on the second channel.

Example 37 includes the method of Example 36, and optionally, wherein the plurality of channels is contiguous.

Example 38 includes the subject matter of any one of Examples 28, 29, 30, 32, 33, 36 and 37, and optionally, wherein the method comprises using self-interference cancellation (SIC) functionality to perform the channel sensing while causing transmission of the first uplink frame.

Example 39 includes the method of Example 38, and optionally, the method further comprising using digital cancellation logic and an analog cancellation circuitry to provide the SIC functionality.

Example 40 includes a wireless communication device, the device comprising: means for causing transmission of a first uplink frame on a first channel; means for performing sensing on a second channel, while causing transmission of the first uplink frame, to determine a busy or an idle status of the second channel; means for performing a backoff procedure to gain access to the second channel in response to a determination of an idle status for the second channel and while causing transmission of the first uplink frame; means for causing switching to the second channel in response to a determination that the second channel still has an idle status after completion of the backoff procedure and after completion of the transmission of the first uplink frame; and means for causing transmission of a second uplink frame on the second channel after causing switching, in response to a determination that the second channel still has an idle status after completion of the backoff procedure and after completion of the transmission of the first uplink frame.

Example 41 includes the subject matter of Example 40, and optionally, wherein the backoff procedure is a first backoff procedure, the device further comprising: means for performing channel sensing on one or more channels, while causing transmission of the first uplink frame and in response to a determination that the second channel has a busy status, to determine a busy or an idle status of the one or more channels; and means for performing a second backoff procedure, while causing transmission of the first uplink frame, in response to a determination that the second channel has a busy status and in response to a determination of an idle status for one of the one or more channels, to gain access to the one of the one or more channels; means for causing switching to the one of the one or more channels in response to a determination that one of the one or more channels has an idle status after completion of the second backoff procedure and after completion of the transmission of the first uplink frame; and means for causing transmission of a second uplink frame on the one of the one or more channels after causing switching.

Example 42 includes the subject matter of Example 40, and optionally, wherein the backoff procedure is a first backoff procedure, the device further comprising: means for performing channel sensing on one or more channels to determine a busy or an idle status of the one or more channels in response to a determination that the second channel has a busy status and after completion of the first backoff procedure and after completion of the transmission of the first uplink frame: means for performing a second backoff procedure in response to a determination that one of the one or more channels has an idle status after performing channel sensing; means for causing switching to the one of the one or more channels after completion of the second backoff procedure; and means for causing transmission of the second uplink frame on the one of the one or more channels after causing switching to the one of the one or more channels.

Example 43 includes the subject matter of any one of Examples 40-42, and optionally, further comprising: means for updating channel occupancy data on the second channel to reflect unavailability of the second channel during the transmission of the first uplink frame, the updating being in response to a determination that, after completion of the transmission of the first uplink frame, the second channel has a busy status and did not have an idle status during the transmission of the first uplink frame; and means for causing transmission of subsequent uplink frames based on the channel occupancy data.

Example 44 includes the subject matter of Example 42, and optionally, wherein the one or more channels include the second channel.

Example 45 includes the subject matter of Example 40, and optionally, further comprising means for performing channel sensing on one or more channels, while causing transmission of the first uplink frame, to determine a busy or an idle status of the one or more channels, the one or more channels including the second channel.

Example 46 includes the subject matter of any one of Examples 40, 41, 42, 44, and 45, and optionally, further comprising means for selecting the second channel as a target channel from one or more channels for channel sensing based on the second channel having a lowest average channel occupancy of the one or more channels.

Example 47 includes the subject matter of Example 40, and optionally, wherein the first uplink frame is addressed to an access point, the device further comprising means for indicating to the access point the switch to the second channel by using a field in the first uplink frame.

Example 48 includes the subject matter of Example 45, and optionally, wherein the one or more channels includes a plurality of channels, the device further comprising: means for simultaneously performing a backoff procedure for each of the one or more of the plurality of channels to gain access to the one or more of the plurality of channels while causing transmission of the first uplink frame, and in response to a determination of an idle status for one or more of the plurality of channels, the one or more of the plurality of channels including the second channel; means for causing switching to the second channel in response to a determination that the second channel is an earliest channel of the one or more of the plurality of channels to have an idle status after completion the backoff procedure pertaining to the second channel and after completion of the transmission of the first uplink frame; and means for causing transmission of the second uplink frame on the second channel after causing switching.

Example 49 includes the subject matter of Example 48, and optionally, wherein the plurality of channels is contiguous.

Example 50 includes the subject matter of Example 40, and optionally, further including means for using self-interference cancellation (SIC) to perform the channel sensing while causing transmission of the first uplink frame.

Example 51 includes the subject matter of Example 50, and optionally, further including means for using digital cancellation logic and an analog cancellation circuitry to provide the SIC functionality.

Example 52 includes a wireless communication device comprising a memory and processing circuitry, the processing circuitry including logic to: decode a first uplink frame from a station, the first uplink frame having been sent on a first channel, the first uplink frame including an indication that the station is to switch to a second channel; based on the indication, cause transmission of a downlink frame to the station only after the station has switched back to the first channel.

Example 53 includes the subject matter of Example 52, and optionally, wherein the uplink frame comprises an aggregated medium access control protocol data unit (A-MPDU) including a delimiter field, and wherein the indication is within the delimiter field.

Example 54 includes the subject matter of Example 52, and optionally, the device comprising a wireless communication system further including a baseband processing circuitry including the memory and the processing circuitry, a radio integrated circuit coupled to the baseband processing circuitry, and a front-end module coupled to the radio integrated circuit.

Example 55 includes the subject matter of any one of Examples 52-54, and optionally, further including a plurality of antennas coupled to the radio IC circuitry.

Example 56 includes a product comprising one or more tangible computer-readable non-transitory storage media comprising computer-executable instructions operable to, when executed by at least one computer processor, cause the at least one computer processor to implement operations at a wireless communication device, the operations comprising: decoding a first uplink frame from a station, the first uplink frame having been sent on a first channel, the first uplink frame including an indication that the station is to switch to a second channel; based on the indication, causing transmission of a downlink frame to the station only after the station has switched back to the first channel.

Example 57 includes the product of Example 56, and optionally, wherein the uplink frame comprises an aggregated medium access control protocol data unit (A-MPDU) including a delimiter field, and wherein the indication is within the delimiter field.

Example 58 includes a method to be performed at a wireless communication device, the method comprising: decoding a first uplink frame from a station, the first uplink frame having been sent on a first channel, the first uplink frame including an indication that the station is to switch to a second channel; based on the indication, causing transmission of a downlink frame to the station only after the station has switched back to the first channel

Example 59 includes the method of Example 58, and optionally, wherein the uplink frame comprises an aggregated medium access control protocol data unit (A-MPDU) including a delimiter field, and wherein the indication is within the delimiter field.

An Abstract is provided. It is submitted with the understanding that it will not be used to limit or interpret the scope or meaning of the claims. The following claims are hereby incorporated into the detailed description, with each claim standing on its own as a separate embodiment.

Functions, operations, components and/or features described herein with reference to one or more embodiments, may be combined with, or may be utilized in combination with, one or more other functions, operations, components and/or features described herein with reference to one or more other embodiments, or vice versa.

While certain features have been illustrated, and described herein, many modifications, substitutions, changes, and equivalents may occur to those skilled in the art. It is, therefore, to be understood that the appended claims are intended to cover all such modifications and changes as fall within the true spirit of the disclosure.

What is claimed is:

1. A wireless communication device comprising a memory and processing circuitry, the processing circuitry including logic to:
cause transmission of a first uplink frame on a first channel;
while causing transmission of the first uplink frame:
perform channel sensing on a second channel to determine a busy or an idle status of the second channel;
in response to a determination of an idle status for the second channel, perform a backoff procedure to gain access to the second channel;
in response to a determination that the second channel still has an idle status after completion of the backoff procedure and after completion of the transmission of the first uplink frame, cause a switch to the second channel and cause transmission of a second uplink frame on the second channel.

2. The device of claim 1, wherein the backoff procedure is a first backoff procedure, the processing circuitry further to:
while causing transmission of the first uplink frame and in response to a determination that the second channel has a busy status:
perform channel sensing on one or more channels to determine a busy or an idle status of the one or more channels; and
in response to a determination of an idle status for one of the one or more channels, perform a second backoff procedure to gain access to the one of the one or more channels;
in response to a determination that one of the one or more channels has an idle status after completion of the second backoff procedure and after completion of the transmission of the first uplink frame, cause a switch to the one of the one or more channels and cause transmission of a second uplink frame on the one of the one or more channels.

3. The device of claim 1, wherein the backoff procedure is a first backoff procedure, the processing circuitry further to, in response to a determination that the second channel has a busy status and after completion of the first backoff procedure and after completion of the transmission of the first uplink frame:
perform channel sensing on one or more channels to determine a busy or an idle status of the one or more channels;
in response to a determination that one of the one or more channels has an idle status, perform a second backoff procedure to gain access to the one of the one or more channels, cause a switch to the one of the one or more channels, and cause transmission of the second uplink frame on the one of the one or more channels.

4. The device of claim 1, the processing circuitry further to, in response to a determination that, after completion of the transmission of the first uplink frame, the second channel has a busy status and did not have an idle status during transmission of the first uplink frame:
update channel occupancy data on the second channel to reflect unavailability of the second channel during the transmission of the first uplink frame; and
causing transmission of subsequent uplink frames based on the channel occupancy data.

5. The device of claim 1, wherein the processing circuitry is further to, while causing transmission of the first uplink frame, perform channel sensing on one or more channels to determine a busy or an idle status of the one or more channels, the one or more channels including the second channel.

6. The device of claim 1, wherein the processing circuitry is further to select the second channel as a target channel from one or more channels for channel sensing based on the second channel having a lowest average channel occupancy of the one or more channels.

7. The device of claim 1, wherein the processing circuitry is further to indicate to an access point to which the first uplink frame is addressed the switch to the second channel by using a field in the second uplink frame.

8. The device of claim 5, wherein the one or more channels includes a plurality of channels, processing circuitry further to:
while causing transmission of the first uplink frame, and in response to a determination of an idle status for one or more of the plurality of channels, the one or more of the plurality of channels including the second channel, simultaneously perform a backoff procedure for each of the one or more of the plurality of channels to gain access to the one or more of the plurality of channels;
in response to a determination that the second channel is an earliest channel of the one or more of the plurality of channels to have an idle status after completion the backoff procedure pertaining to the second channel and after completion of the transmission of the first uplink frame, cause a switch to the second channel and cause transmission of the second uplink frame on the second channel.

9. The device of claim 1, wherein the device is configured to implement self-interference cancellation (SIC) functionality to perform the channel sensing while causing transmission of the first uplink frame

10. The device of claim 9, the device comprising a wireless communication system further including:
a baseband processing circuitry including the memory and the processing circuitry;
a radio integrated circuit coupled to the baseband processing circuitry;
a front-end module coupled to the radio integrated circuit; and
digital cancellation logic and analog cancellation circuitry to provide the self-interference cancellation (SIC) functionality.

11. The device of claim 10, further including a plurality of antennas coupled to the radio IC circuitry.

12. A product comprising one or more tangible computer-readable non-transitory storage media comprising computer-executable instructions operable to, when executed by at least one computer processor, cause the at least one computer processor to implement operations at a wireless communication device, the operations comprising:
causing transmission of a first uplink frame on a first channel;
while causing transmission of the first uplink frame:
performing channel sensing on a second channel to determine a busy or an idle status of the second channel;
in response to a determination of an idle status for the second channel, performing a backoff procedure to gain access to the second channel;
in response to a determination that the second channel still has an idle status after completion of the backoff procedure and after completion of the transmission of the first uplink frame, causing switching to the second channel and causing transmission of a second uplink frame on the second channel.

13. The product of claim 12, wherein the backoff procedure is a first backoff procedure, the method further comprising:
while causing transmission of the first uplink frame and in response to a determination that the second channel has a busy status:
performing channel sensing on one or more channels to determine a busy or an idle status of the one or more channels; and
in response to a determination of an idle status for one of the one or more channels, performing a second backoff procedure to gain access to the one of the one or more channels;
in response to a determination that one of the one or more channels has an idle status after completion of the second backoff procedure and after completion of the transmission of the first uplink frame, causing switching to the one of the one or more channels and causing transmission of a second uplink frame on the one of the one or more channels.

14. The product of claim 12, wherein the backoff procedure is a first backoff procedure, the operations further including, in response to a determination that the second channel has a busy status and after completion of the first backoff procedure and after completion of the transmission of the first uplink frame:
performing channel sensing on one or more channels to determine a busy or an idle status of the one or more channels;
in response to a determination that one of the one or more channels has an idle status, performing a second backoff procedure to gain access to the one of the one or more channels, causing switching to the one of the one or more channels, and causing transmission of the second uplink frame on the one of the one or more channels.

15. The product of claim 12, the operations further including, in response to a determination that, after completion of the transmission of the first uplink frame, the second channel has a busy status and did not have an idle status during the transmission of the first uplink frame:
updating channel occupancy data on the second channel to reflect unavailability of the second channel during the transmission of the first uplink frame; and
causing transmission of subsequent uplink frames based on the channel occupancy data.

16. The product of claim 12, wherein the operations further include, while causing transmission of the first uplink frame, performing channel sensing on one or more channels to determine a busy or an idle status of the one or more channels, the one or more channels including the second channel.

17. The product of claim 12, wherein the operations further include selecting the second channel as a target channel from one or more channels for channel sensing based on the second channel having a lowest average channel occupancy of the one or more channels.

18. The product of claim 12, wherein the operations further include indicating to the AP the switch to the second channel by using a field in the second uplink frame.

19. The product of claim 16, wherein the one or more channels includes a plurality of channels, the operations further including:
while causing transmission of the first uplink frame, and in response to a determination of an idle status for one or more of the plurality of channels, the one or more of the plurality of channels including the second channel, simultaneously performing a backoff procedure for each of the one or more of the plurality of channels to gain access to the one or more of the plurality of channels;
in response to a determination that the second channel is an earliest channel of the one or more of the plurality of channels to have an idle status after completion the backoff procedure pertaining to the second channel and after completion of the transmission of the first uplink frame, causing switching to the second channel and causing transmission of the second uplink frame on the second channel.

20. The product of claim 12, wherein the operations include using self-interference cancellation (SIC) functionality to perform the channel sensing while causing transmission of the first uplink frame.

21. A method of operating a wireless communication device, the method comprising:
causing transmission of a first uplink frame on a first channel;
while causing transmission of the first uplink frame:
performing channel sensing on a second channel to determine a busy or an idle status of the second channel;
in response to a determination of an idle status for the second channel, performing a backoff procedure to gain access to the second channel;
in response to a determination that the second channel still has an idle status after completion of the backoff procedure and after completion of the transmission of the first uplink frame, causing switching to the second channel and causing transmission of a second uplink frame on the second channel.

22. The method of claim 21, wherein the backoff procedure is a first backoff procedure, the method further comprising:
while causing transmission of the first uplink frame and in response to a determination that the second channel has a busy status:
performing channel sensing on one or more channels to determine a busy or an idle status of the one or more channels; and
in response to a determination of an idle status for one of the one or more channels, performing a second backoff procedure to gain access to the one of the one or more channels;
in response to a determination that one of the one or more channels has an idle status after completion of the second backoff procedure and after completion of the transmission of the first uplink frame, causing switching to the one of the one or more channels and causing transmission of a second uplink frame on the one of the one or more channels.

23. The method of claim 21, wherein the backoff procedure is a first backoff procedure, the method further comprising, in response to a determination that the second channel has a busy status and after completion of the first backoff procedure and after completion of the transmission of the first uplink frame:
performing channel sensing on one or more channels to determine a busy or an idle status of the one or more channels; and
in response to a determination that one of the one or more channels has an idle status, performing a second backoff procedure to gain access to the one of the one or more channels, causing switching to the one of the one or more channels, and causing transmission of the second uplink frame on the one of the one or more channels.

24. The method of claim 21, the method further comprising, in response to a determination that, after completion of the transmission of the first uplink frame, the second channel has a busy status and did not have an idle status during the transmission of the first uplink frame:
updating channel occupancy data on the second channel to reflect unavailability of the second channel during the transmission of the first uplink frame; and
causing transmission of subsequent uplink frames based on the channel occupancy data.

25. The method of claim 21, wherein the method further comprises indicating to the AP the switch to the second channel by using a field in the second uplink frame.
